(19) United States
(12) Patent Application Publication
(10) Pub. No.: US 2022/0356367 A1
(43) Pub. Date: Nov. 10, 2022

(54) BASE MATERIAL WITH COATING FILM, AND METHOD FOR ITS PRODUCTION

(71) Applicant: AGC Inc., Tokyo (JP)

(72) Inventor: Ryosuke KAMITANI, Tokyo (JP)

(73) Assignee: AGC Inc., Tokyo (JP)

(21) Appl. No.: 17/872,116

(22) Filed: Jul. 25, 2022

Related U.S. Application Data
(63) Continuation of application No. PCT/JP2021/006397, filed on Feb. 19, 2021.

(30) Foreign Application Priority Data
Feb. 28, 2020 (JP) 2020-033334

(51) Int. Cl. C09D 127/18; C09D 5/08; C09D 7/20; C09D 127/04

(52) U.S. Cl. CPC C09D 127/18; C09D 5/08; C09D 7/20; C09D 127/04

(57) ABSTRACT

To provide a base material with a particulate coating film that, when coated on the surface of a porous body, can form a porous film layer that is resistant to powder fallout while maintaining the pores in the porous body.

The base material with a coating film, comprising a base material being particles, and a coating film of a fluororesin covering the surface of the base material, wherein the melt flow rate of the fluororesin is from 0.01 to 100 g/10 min.

### TECHNICAL FIELD

The present invention relates to a base material with a coating film and a method for its production.

### BACKGROUND ART

A fluororesin such as an ethylene-tetrafluoroethylene copolymer is used in various applications where a general-purpose plastic cannot be used, because it is excellent in solvent resistance, low dielectric properties, low surface energy, non-adhesiveness, weather resistance, etc. For example, by coating a fluororesin on the surface of a base material, it is possible to impart the above properties.

An ethylene-tetrafluoroethylene copolymer is generally insoluble in a solvent and is processed mainly by a melting method (extrusion molding, injection molding, powder coating, etc.), but a technique to solubilize ETFE is also being investigated.

Patent Document 1 discloses a method of forming a coating film on a base material by coating a composition containing an ethylene-tetrafluoroethylene copolymer and a C₆₋₁₀ aliphatic hydrocarbon compound having one carbonyl group. In Patent Document 1, in order to enhance the coating property of the composition, as the ethylene-tetrafluoroethylene copolymer, one having from 0.4 to 0.8 mol % of functional groups such as carbonyl group-containing groups, is used.

In a lithium-ion secondary battery, a porous film layer containing an inorganic filler such as alumina and a binder may sometimes be provided on at least one surface of the separator for the purpose of preventing short circuiting due to shrinkage of the separator as a whole. Further, as a binder for the porous film layer, a fluororesin is sometimes used because of its excellent heat resistance and dissolution resistance to the electrolyte. The porous film layer in which the binder is a fluororesin may be formed, for example, by coating the separator with a dispersion having the inorganic filler and the fluororesin dispersed in a dispersant, followed by drying.

### PRIOR ART DOCUMENT

### Patent Document

Patent Document 1: WO2019/031521

### DISCLOSURE OF INVENTION

### Technical Problem

However, in the porous film layer formed by using the above dispersion, the fluororesin being the binder, is in a particle form, whereby the contact area between the inorganic filler or the base material and the fluororesin, is small. Therefore, the bonding force between inorganic fillers, or between the inorganic filler and the base material, is weak, and powder fallout wherein the inorganic filler falls out of the porous film layer, is likely to occur. Once the powder fallout occurs, not only the function of the porous film layer will be impaired, but also it becomes a foreign substance in the electrode lamination process during the battery production, whereby the battery characteristics themselves will be impaired.

The present inventor studied adding an inorganic filler to the composition described in Patent Document 1 and coating the separator with it to form a porous film layer. However, in this case, there was still a problem of powder fallout. Furthermore, there was also such a problem that the ethylene-tetrafluoroethylene copolymer blocked the pores of the separator, whereby separator performance was impaired.

According to the study by the present inventor, the composition disclosed in Patent Document 1 is, even if it is in a solution state on appearance, actually one in which the ethylene-tetrafluoroethylene copolymer is dispersed in nano-order size. Also in the porous film layer to be formed, the ethylene-tetrafluoroethylene copolymer is in a particle form, whereby the bonding force between inorganic fillers, or between the inorganic filler and the base material, is considered to be weak. Further, since the size of the ethylene-tetrafluoroethylene copolymer is small, the ethylene-tetrafluoroethylene copolymer is considered to easily penetrate into pores of the separator during coating.

If an inorganic filler having a coating film of a fluororesin preliminarily formed on the entire surface, is dispersed in a dispersant, and coated on the separator, the coating film is considered to function as a binder, whereby it is possible to form a porous film layer. Further, it is considered that the contact area between the inorganic filler or the base material and the fluororesin will increase, and the bonding force between inorganic fillers, or between the inorganic filler and the base material, will increase, thereby preventing powder fallout, and there will be no such a problem that the fluororesin will block pores in the separator.

However, according to the study by the present inventor, in a case where particles such as the inorganic filler are the base material, it is not possible to form a coating film by the method of Patent Document 1.

Also in a case where a porous body is the base material, it is not possible to form a coating film by the method of Patent Document 1. Further, pores of the porous body will be blocked by the ethylene-tetrafluoroethylene copolymer, whereby the performance of the porous body will be impaired.

One embodiment of the present invention has an object to provide a base material with a particulate coating film, which is, when coated on the surface of a porous body, capable of forming a porous film layer which does not block pores of the porous body and is resistant to powder fallout.

Another embodiment of the present invention has an object to provide a base material with a porous coating film, which is capable of fully expressing performance as a porous body and is excellent in hydrophobicity, etc. of the surface of the pores.

Another embodiment of the present invention has an object to provide a method for producing a base material with a coating film, which is capable of forming a coating film of a fluororesin on the surface of a base material even when the base material is particles or a porous body.

### Solution to Problem

The present invention has the following embodiments.
[1] A base material with a coating film, comprising a base material being particles or a porous body, and a coating film of a fluororesin covering the surface of the base material, wherein the melt flow rate of the fluororesin is from 0.01 to 100 g/10 min.
[2] The base material with a coating film according to [1], wherein the average thickness of the coating film is at most 1 μm.
[3] The base material with a coating film according to [1] or [2], wherein the fluororesin is at least one member selected from the group consisting of a polymer having units based on tetrafluoroethylene, a copolymer having units based on ethylene and units based on tetrafluoroethylene, a copolymer having units based on a perfluoro(alkyl vinyl ether) and units based on tetrafluoroethylene, a copolymer having units based on hexafluoropropylene and units based on tetrafluoroethylene, and a polymer having units based on chlorotrifluoroethylene.
[4] The base material with a coating film according to any one of [1] to [3], wherein the base material is an inorganic base material.
[5] A method for producing a base material with a coating film, which comprises heating a base material, a fluororesin having a melt flow rate of from 0.01 to 100 g/10 min. and a halogenated solvent in such a state as they are brought into contact with one another, to a temperature T₁ of at least (the melting point of the fluororesin −20° C.) and less than (the decomposition temperature of the fluororesin), and cooling them to a temperature T₂ of at most (the melting point of the fluororesin −50° C.).
[6] The production method according to [5], wherein the base material is particles or a porous body.
[7] The production method according to [5] or [6], wherein the halogen content of the halogenated solvent is from 60 to 96 mass %.
[8] The production method according to any one of [5] to [7], wherein the weight average molecular weight of the halogenated solvent is from 130 to 1,500.
[9] The production method according to any one of [5] to [8], wherein the fluororesin is at least one member selected from the group consisting of a polymer having units based on tetrafluoroethylene, a copolymer having units based on ethylene and units based on tetrafluoroethylene, a copolymer having units based on a perfluoro(alkyl vinyl ether) and units based on tetrafluoroethylene, a copolymer having units based on hexafluoropropylene and units based on tetrafluoroethylene, and a polymer having units based on chlorotrifluoroethylene.
[10] The production method according to any one of [5] to [9], wherein the base material is an inorganic base material.
[11] The production method according to any one of [5] to [10], wherein the cooling rate at the time of cooling to the temperature T₂ is at most 5° C./min.
[12] The production method according to any one of [5] to [11], wherein the proportion of the fluororesin to 100 parts by mass of the halogenated solvent is more than 0 part by mass and at most 30 parts by mass.
[13] The production method according to any one of [5] to [12], wherein the base material is particles, and the proportion of the base material to 100 parts by mass of the halogenated solvent is from 0.1 to 30 parts by mass.

### Advantageous Effects of Invention

The base material with a coating film according to one embodiment of the present invention has a coating film of a fluororesin covering the surface of the base material being particles. According to the base material with a coating film of this embodiment, when coated on the surface of a porous body, it is possible to form a porous film layer, which is less likely to undergo powder fallout while maintaining pores of the porous body.

The base material with a coating film according to another embodiment of the present invention has a coating film of a fluororesin covering the surface of the base material being a porous body. According to the base material with a coating film of this embodiment, it is possible to fully express the performance as a porous body and is excellent in hydrophobicity of the surface of pores.

According to the method for producing a base material with a coating film according to another embodiment of the present invention, it is possible to form a coating film of a fluororesin on the surface of a base material even when the base material is particles or a porous body.

### BRIEF DESCRIPTION OF DRAWINGS

FIG. 1 is a schematic cross-sectional view of a base material with a coating film according to one embodiment.

FIG. 2 is a schematic cross-sectional view of a base material with a coating film according to another embodiment.

FIG. 3 is a schematic cross-sectional view showing a state where a porous film layer consisting of a plurality of base materials with coating films, is formed on a separator of a lithium-ion secondary battery.

FIG. 4 is FT-IR spectra of alumina particles with a coating film in Ex. 1 to 4 and alumina particles before forming a coating film (alumina particles before modification).

FIG. 5 is EDS mapping images of alumina particles with a coating film in Ex. 1 (from left to right: F atoms, Al atoms, and O atoms).

FIG. 6 is EDS mapping images of alumina particles with a coating film in Ex. 2 (from left to right: F atoms, Al atoms, and O atoms).

FIG. 7 is EDS mapping images of alumina particles with a coating film in Ex. 3 (from left to right: F atoms, Al atoms, and O atoms).

FIG. 8 is EDS mapping images of alumina particles with a coating film in Ex. 4 (from left to right: F atoms, Al atoms, and O atoms).

FIG. 9 is EDS mapping images of alumina particles with a coating film in Ex. 5 (from left to right: F atoms, Al atoms, and O atoms).

FIG. 10 is EDS mapping images of alumina particles with a coating film in Ex. 6 (from left to right: F atoms, Al atoms, and O atoms).

### DESCRIPTION OF EMBODIMENTS

The meanings of the following terms in the present invention are as follows.

The “melt flow rate” (hereinafter referred to also as “MFR”) is a melt flow rate as defined in JIS K7210:1999 (IS01133:1997).

The “melting point” is the temperature corresponding to the maximum value of the melting peak of the resin as measured by differential scanning calorimetry (DSC).

The “decomposition temperature” is the temperature at which a weight decrease begins when simultaneous thermogravimeter-differential thermal analysis (TG-DTA) is conducted under atmospheric conditions.

The “average thickness of the coating film” is the value obtainable by dividing the resin volume, which is determined by the film mass and resin density obtainable by TG-DTA, etc., by the particle surface area.

The “units based on a monomer” is a generic term for an atomic group directly formed by polymerization of a single monomer molecule and an atomic group obtainable by chemical conversion of a portion of the atomic group. In this specification, the units based on a monomer may simply be referred to as monomer units.

A “monomer” means a compound having a polymerizable carbon-carbon double bond.

The expression “to” indicating a numerical range means to include the numerical values listed before and after it as the lower and upper limit values.

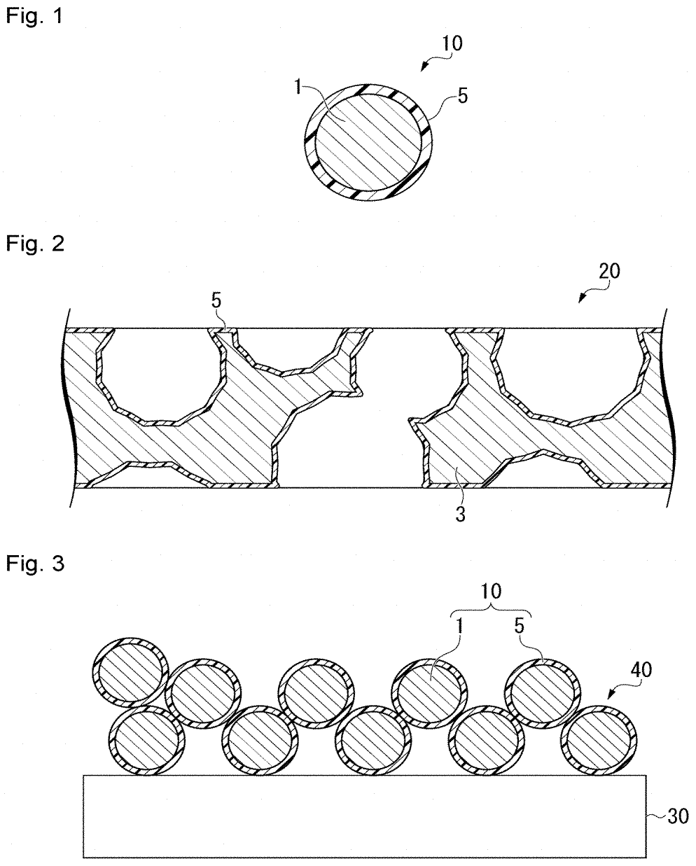

The dimensional ratios in FIG. 1 to FIG. 3 are different from the actual ones for illustrative purposes.

[Base Material with Coating Film]

A base material with a coating film according to one embodiment of the present invention comprises a base material being particles or a porous body, and a coating film of a fluororesin covering the surface of the base material.

The base material with a coating film, in which the base material is particles, is particles in shape like the base material.

The base material with a coating film, in which the base material is a porous body, is porous in shape like the base material.

FIG. 1 is a schematic cross-sectional view of a base material 10 with a coating film according to one embodiment.

The base material 10 with a coating film, comprises a base material 1 being a particle, and a coating film 5 of a fluororesin covering the surface of the base material 1.

FIG. 2 is a schematic cross-sectional view of a base material 20 with a coating film according to another embodiment.

The base material 20 with a coating film comprises a base material 3 being a porous body, and a coating film 5 of a fluororesin covering the surface of the base material 3.

### (Base Material)

As the material to constitute the base material, an organic material, an inorganic material, etc. may be mentioned. An organic material and an inorganic material may be used in combination.

As the organic material, a resin with a melting point higher than the fluororesin to constitute the coating film, is preferred, such as a high molecular weight polytetrafluoroethylene. The high molecular weight polytetrafluoroethylene generally has a tensile strength of at least 20 MPa as measured by ASTM D4894.

As the inorganic material, a non-conductive inorganic material such as an oxide ceramic (such as alumina, silica, titania, zirconia, magnesia, ceria, yttria, zinc oxide, iron oxide, etc.), a nitride ceramic (such as silicon nitride, titanium nitride, boron nitride, etc.), silicon carbide, calcium carbonate, aluminum sulfate, aluminum hydroxide, potassium titanate, talc, kaolin clay, kaolinite, halloysite, pyrophyllite, montmorillonite, sericite, mica, amesite, bentonite, asbestos, zeolite, calcium silicate, magnesium silicate, siliceous earth, silica sand, glass fiber, etc.; a conductive inorganic material e.g. carbon such as carbon black, graphite, etc., SnO₂, ITO, a metal (such as gold, silver, copper, iron, titanium, zirconium, etc.); etc. may be mentioned.

As the material to constitute the base material, an inorganic material is preferred from the viewpoint of the heat resistance and dissolution resistance. That is, the base material is preferably an inorganic base material made of an inorganic material.

The shape and material of the base material may suitably be selected according to the application of the base material with a coating film.

For example, in a case where the base material with a coating film is to be used as a coating material for a separator of a lithium-ion secondary battery, the base material is particles. As the particles, particles of a non-conductive inorganic material are preferred, but ones having the surface of particles of a conductive inorganic material surface-treated with a non-conductive inorganic material, or particles of a conductive inorganic material, may also be used. In a case where metal particles are to be used as particles of a conductive inorganic material, as such metal particles, particles of a metal which do not react with HF are preferred. If the base material contains a metal which reacts with HF (e.g. iron, titanium, zirconium, etc.), it may react with HF to generate H₂.

In a case where the base material with a coating film is to be used as an electrode for electrolysis of water, the base material is a porous body made of a conductive inorganic material. In such a case, carbon is preferred as the conductive inorganic material.

In a case where the base material is particles, the shape of the particles may be spherical, needle, rod, cone, plate, scale, fiber, etc.

The average particle size varies depending on the application, but for example, in a case where the base material with a coating film is to be used as a coating material for a separator of a lithium-ion secondary battery, from 5 nm to 10 μm is preferred, from 10 nm to 5 μm is more preferred, and from 50 nm to 2 μm is further preferred. When the average particle size is within the above mentioned range, it will be easier to control the dispersion state of the base material with a coating film and to obtain a porous film layer with a homogeneous thickness.

The average particle size is the volume-based cumulative 50% diameter to be obtained by the laser diffraction and scattering method. That is, the particle size distribution is measured by the laser diffraction and scattering method, and a cumulative curve is obtained with the total volume of the particle population as 100%, whereby it is a particle size at the point on the cumulative curve where the cumulative volume becomes to be 50%.

In a case where the base material is a porous body, the shape of the porous body may be a sheet, rod or the like. When the porous body is in a sheet form, the thickness of the porous body varies depending on the application, but, for example, in a case where the base material with a coating film is to be used as an electrode for electrolysis of water, from 10 to 1,000 μm is preferred, and from 100 to 300 μm is more preferred.

The average pore diameter of the porous body varies depending on the application, but, for example, in a case where the base material with a coating film is to be used as an electrode for electrolysis of water, from 5 to 1,000 nm is preferred, and from 10 to 200 nm is more preferred. The average pore diameter is obtainable by gas adsorption method, etc.

### (Coating Film of Fluororesin)

MFR of the fluororesin to constitute the coating film is from 0.01 to 100 g/10 min, preferably from 0.1 to 100 g/10 min, more preferably from 1.0 to 100 g/10 min. When MFR is within the above range, it will be easier to form a coating film of the fluororesin on the surface of the base material by the production method as described below.

Further, MFR in a case where the fluororesin is PTFE as described below, is preferably from 0.01 to 1.0 g/min.

MFR of the fluororesin is measured under a load of 49N at a temperature higher by at least 20° C. than the melting point of the fluororesin. As the measurement temperature, for PFA or PTFE as described below, 372° C. is preferred, and for ETFE, 297° C. is preferred.

MFR of the fluororesin may be adjusted by the molecular weight of the fluororesin. The smaller the molecular weight, the higher the MFR tends to be. The molecular weight of the fluororesin may be adjusted by the production conditions of the fluororesin.

The melting point of the fluororesin is preferably from 50 to 330° C., more preferably from 100 to 325° C., further preferably from 150 to 320° C., particularly preferably from 170 to 310° C. When the melting point is at least the above lower limit value, the heat resistance will be more excellent, and when the melting point is at most the above upper limit value, it will be easier to form a coating film of the fluororesin on the surface of the base material by the production method as described below.

The decomposition temperature of the fluororesin is preferably at least 300° C., more preferably at least 400° C. When the decomposition temperature is at least the above lower limit value, it will be easier to form a coating film of the fluororesin on the surface of the base material in the production method as described below.

The fluororesin may have at least one type of functional group (hereinafter referred to also as a “functional group I”) selected from the group consisting of a carbonyl group-containing group, a hydroxy group, an epoxy group, an amide group, an amino group and an isocyanate group. By having a functional group I, adhesion between the coating film and the base material, adhesion between the base materials with coating films, etc. will be more excellent.

The carbonyl group-containing group is a group having a carbonyl group (—C(═O)—) in its structure.

As the carbonyl group-containing group, a group having a carbonyl group between carbon atoms of a hydrocarbon group, a carbonate group, a carboxy group, a haloformyl group, an alkoxycarbonyl group, an acid anhydride group (—C(═O)—O—C(═O)—), etc. may be mentioned.

As the hydrocarbon group in the group having a carbonyl group between the carbon atoms of the hydrocarbon group, for example, a C₂₋₈ alkylene group may be mentioned. Here, the number of carbon atoms in the alkylene group is the number of carbon atoms in a state not containing carbon to constitute the carbonyl group. The alkylene group may be linear or branched.

The haloformyl group is represented by —C(═O)—X (where X is a halogen atom). As the halogen atom in the haloformyl group, a fluorine atom, a chlorine atom, etc. may be mentioned, and a fluorine atom is preferred. That is, as the haloformyl group, a fluoroformyl group (referred to also as a carbonyl fluoride group) is preferred.

The alkoxy group in the alkoxycarbonyl group may be linear or branched, a C₁₋₈ alkoxy group is preferred, and a methoxy group or an ethoxy group is particularly preferred.

In a case where the fluororesin has a functional group I, the functional group I in the fluororesin may be one type or more than one type. From the viewpoint of adhesion between the coating film and the base material, or between the base materials with coating films, it is preferred that at least part of the functional group I in the fluororesin is a carbonyl group-containing group.

In a case where the fluororesin has a functional group I, the functional group I is preferably present as either one or both of a terminal group of the main chain of the fluororesin and a pendant group of the main chain.

In a case where the fluororesin has a functional group I, the content of the functional group I in the fluororesin is preferably from 10 to 60,000, more preferably from 100 to 50,000, further preferably from 100 to 10,000, particularly preferably from 300 to 5,000, to the number of carbon atoms in the main chain of the fluororesin being 1×10⁶. When the content of the functional group I is at least the above lower limit value, adhesion between the coating film and the base material, adhesion between the base materials with coating films, etc. will be more excellent, and when the content is at most the above upper limit value, the melt processability and thermal stability will be more excellent.

The content of the functional group I may be measured by a method such as a nuclear magnetic resonance (NMR) analysis, an infrared absorption spectrum analysis, or the like. For example, by using a method such as an infrared absorption spectrum analysis as described in JP-A-2007-314720, the proportion (mol %) of units having a functional group I in all units constituting the fluororesin is obtained, and from this proportion, the content of the functional group I can be calculated.

As the fluororesin, a polymer having tetrafluoroethylene (hereinafter referred to also as “TFE”) units (hereinafter referred to also as “PTFE”), a copolymer having ethylene units and TFE units (hereinafter referred to also as “ETFE”), a copolymer having perfluoro(alkyl vinyl ether) (hereinafter referred to also as “PAVE”) units and TFE units (hereinafter referred to also as “PFA”), a copolymer having hexafluoropropylene (hereinafter referred to also as “HFP”) units and TFE units (hereinafter referred to also as “FEP”), and a polymer having chlorotrifluoroethylene units (hereinafter referred to also as “PCTFE”), may be mentioned. One of these fluororesins may be used alone, or two or more of them may be used in combination.

As PAVE, for example, CF₂═CFOR^{f1} (where R^{f1} is a C₁₋₁₀ perfluoroalkyl group which may contain an oxygen atom between carbon atoms) may be mentioned. As specific examples, CF₂═CFOCF₂CF₃, CF₂═CFOCF₂CF₂CF₃, CF₂═CFOCF₂CF₂CF₂CF₃ and CF₂═CFO(CF₂)₆F may be mentioned. As PAVE, CF₂═CFOCF₂CF₂CF₃ is preferred.

Each of these fluororesins may have a functional group I.

Each of these fluororesins may have additional other monomer units. Other monomers are monomers other than the monomers that characterize the fluororesin. For example, in the case of PTFE, they are monomers other than TFE, in the case of ETFE, they are monomers other than ethylene and TFE, and in the case of PFA, they are monomers other than PAVE and TFE.

Other monomers in these fluororesins may, for example, be fluorinated monomers (excluding TFE in the case of PTFE and ETFE, excluding PAVE and TFE in the case of PFA, excluding HFP and TFE in the case of FEP, and excluding chlorotrifluoroethylene in the case of PCTFE), and monomers having no fluorine atoms (but excluding ethylene in the case of ETFE) (hereinafter referred to also as “non-fluorinated monomers”).

As the fluorinated monomer, a fluorinated compound having one polymerizable carbon-carbon double bond, is preferred, and, for example, a fluoroolefin, PAVE, CF₂═CFOR^{f2}SO₂X¹ (where R^{f2} is a C₁₋₁₀ perfluoroalkylene group which may contain an oxygen atom between carbon atoms, and X¹ is a halogen atom or a hydroxy group), CF₂═CFOR^{f3}CO₂X² (where R^{f3} is a C₁₋₁₀ perfluoroalkylene group which may contain an oxygen atom between carbon atoms, and X² is a hydrogen atom or a C₁₋₃ alkyl group), CF₂═CF(CF₂)ₚOCF═CF₂ (where p is 1 or 2), a fluorinated monomer having a ring structure (such as perfluoro(2,2-dimethyl-1,3-dioxol), 2,2,4-trifluoro-5-trifluoromethoxy-1,3-dioxol, perfluoro(2-methylene-4-methyl-1,3-dioxolane, etc.), etc., may be mentioned.

As the fluoroolefin, TFE, vinyl fluoride, vinylidene fluoride, trifluoroethylene, chlorotrifluoroethylene, HFP, hexafluoroisobutylene, CH₂═CX³(CF₂)_{q}X⁴ (where X³ is a hydrogen or a fluorine atom, q is an integer of from 2 to 10, and X⁴ is a hydrogen atom or a fluorine atom), etc. may be mentioned.

As specific examples of CH₂═CX³(CF₂)_{q}X⁴, CH₂═CF(CF₂)₂F, CH₂═CF(CF₂)₃F, CH₂═CF(CF₂)₄F, CH₂═CF(CF₂)₅F, CH₂═CF(CF₂)₆F, CH₂═CF(CF₂)₂H, CH₂═CF(CF₂)₃H, CH₂═CF(CF₂)₄H, CH₂═CF(CF₂)₅H, CH₂═CF(CF₂)₆H, CH₂═CH(CF₂)₂F, CH₂═CH(CF₂)₃F, CH₂═CH(CF₂)₄F, CH₂═CH(CF₂)₅F, CH₂═CH(CF₂)₆F, CH₂═CH(CF₂)₂H, CH₂═CH(CF₂)₃H, CH₂═CH(CF₂)₄H, CH₂═CH(CF₂)₆H, CH₂═CH(CF₂)₆H may be mentioned.

As the non-fluorinated monomer, a non-fluorinated monomer having a functional group I or a non-fluorinated monomer having no functional group I may be mentioned.

As the non-fluorinated monomer having a functional group I, a monomer having a carboxy group (such as maleic acid, itaconic acid, citraconic acid, undecylenic acid, etc.), a monomer having an acid anhydride group (such as itaconic anhydride (hereinafter referred to also as “IAH), a citraconic anhydride (hereinafter referred to also as “CAH”), 5-norbornene-2,3-dicarboxylic anhydride (hereinafter referred to also as “NAH), maleic anhydride, etc.), a monomer having a hydroxy group (such as hydroxybutyl vinyl ether, etc.), a monomer having an epoxy group (such as glycidyl vinyl ether, etc.), etc., may be mentioned.

As the non-fluorinated monomer having no functional group I, a non-fluorinated compound having one polymerizable carbon-carbon double bond, is preferred, and, for example, an olefin (such as ethylene, propylene, 1-butene, isobutene, etc.), a vinyl ester (such as vinyl acetate, etc.), a vinyl ether (such as ethyl vinyl ether, butyl vinyl ether, cyclohexyl vinyl ether, etc.), etc., may be mentioned.

As other monomers, one type may be used alone, or two or more types may be used in combination.

The proportion of other monomer units is preferably from 0.01 to 5.0 mol %, more preferably from 0.03 to 3.0 mol %, further preferably from 0.05 to 1.0 mol %, to 100 mol % in total of all units constituting the fluororesin.

As the fluororesin, one type may be used alone, or two or more types may be used in combination.

As the fluororesin, at least one type selected from the group consisting of PTFE, ETFE, PFA, FEP and PCTFE, is preferred. These fluororesins are generally insoluble in solvents and are processed mainly by melting methods (extrusion molding, injection molding, powder coating, etc.), making them highly useful for the present invention. Among them, ETFE is preferred due to its solubility in a halogenated solvent.

As the fluororesin, a commercially available one may be used, or one produced by a known method may be used. For example, by the method described in Japanese Patent No. 6,546,143, it is possible to produce PTFE with an MFR of from 0.01 to 1.0 g/min. Further, a functional group I may also be introduced into such PTFE. As the method of introducing a functional group I, for example, a method described in WO2019/031521 may be mentioned.

The average thickness of the coating film is preferably at most 1 μm, more preferably at most 500 nm, further preferably at most 100 nm. When the average thickness is at most the above mentioned upper limit value, in a case where the base material is particles, the coating can be applied without significantly changing the particle diameter, and in a case where the base material is a porous body, pores in the base material are less likely to be blocked, and the performance of the base material can be fully expressed.

The average thickness of the coating film is preferably at least 1 nm, more preferably at least 2 nm, further preferably at least 5 nm. If the average thickness is at least the above lower limit value, the coating can be made without creating defects, and the uniformity of the thickness of the coating film on the surface of the base material will be more excellent.

The base material with a coating film according to this embodiment can be produced, for example, by the method for producing a base material with a coating film as described below. However, the method of producing the base material with a coating film of this embodiment is not limited to this.

(Applications of the Base Material with a Coating Film)

A base material with a coating film, in which the base material is particles, can be used, for example, as a coating material for a separator of a lithium-ion secondary battery. A base material with a coating film, in which the base material is a porous body, can be used, for example, as an electrode for electrolysis of water. However, applications of the base material with a coating film, are not limited to these.

In the following, a method of using a base material with a coating film, in which the base material is particles, as a coating material for a separator of a lithium-ion secondary battery, will be described in detail with reference to FIG. 3.

First, a dispersion is prepared by dispersing a plurality of base materials 10 with a coating film, in a dispersant. Then, the dispersion is coated on the separator 30, or the separator 30 is immersed in the dispersion, followed by drying. Thereby, as shown in FIG. 3, a porous film layer 40 consisting of the plurality of base materials 10 with a coating film, will be formed, on the separator 30.

As the dispersant, water, an organic solvent, etc. may be mentioned. As the organic solvent, an aromatic hydrocarbon (such as benzene, toluene, xylene, ethylbenzene, etc.), a chlorinated aliphatic hydrocarbon (such as methylene chloride, chloroform, carbon tetrachloride, etc.), pyridine, acetone, dioxane, N,N-dimethylformamide, methyl ethyl ketone, diisopropyl ketone, cyclohexanone, tetrahydrofuran, n-butyl phthalate, methyl phthalate, ethyl phthalate, tetrahydrofurfuryl alcohol, ethyl acetate, butyl acetate, 1-nitropropane, carbon disulfide, tributyl phosphate, cyclohexane, cyclopentane, methylcyclohexane, ethylcyclohexane, N-methylpyrrolidone, etc. may be mentioned. As the dispersant, one type may be used alone, or two or more types may be used in combination. Further, the above dispersant may be water only, an organic solvent only, or a combination of water and an organic solvent.

The dispersion may contain other components (such as a dispersant, a leveling agent, a defoaming agent, an electrolyte additive having a function of inhibiting electrolyte degradation, a thickening agent, etc.).

The solid content concentration of the dispersion may be suitably set within the range where coating or impregnation is possible, e.g. from 5 to 50 mass %.

The dispersion is obtainable by mixing the base material 10 with a coating film, a dispersant, and, as the case requires, other components, by using a mixing device.

The mixing device may be any device so long as it is capable of uniformly mixing the respective components. As the mixing device, a high dispersion equipment (such as a bead mill, a roll mill, a filmix, etc.), a ball mill, a sand mill, a pigment dispersion machine, a grinding machine, an ultrasonic dispersion machine, a homogenizer, a planetary mixer, etc., may be mentioned.

The separator 30 is a microporous base material made of an organic material which has electrically insulating properties, will have ion-conductivity when impregnated with an electrolyte, and has high resistance to an electrolyte (solvent). As the microporous base material, a microporous film, a fabric (woven fabric, non-woven, etc.), or an aggregate of insulating material particles, may be mentioned, and a microporous film is preferred. The separator 30 may be one having a plurality of microporous base materials laminated.

As the organic material to constitute the separator 30, a polyolefin (polyethylene, polypropylene, polybutene, etc.), polyvinyl chloride, polyethylene terephthalate, polycycloolefin, polyethersulfone, polyimide, polyimide, polyimidoamide, polyaramid, polytetrafluoroethylene, etc. may be mentioned.

The thickness of the separator 30 is, for example, from 0.5 to 40 μm.

As the method of coating the dispersion, a doctor blade method, a dip method, a reverse roll method, a direct roll method, a gravure method, an extrusion method, a brush coating method, etc. may be mentioned, and the dip method or the gravure method is preferred from such a viewpoint that a uniform porous film layer can be formed.

As the drying method, a drying method by warm air, hot air or low-humidity air, a vacuum drying method, or drying method by irradiation with e.g. (far) infrared rays, electron beams, etc., may be mentioned. The drying temperature depends on the type of the dispersant. In a case where a low volatile dispersant such as N-methylpyrrolidone is to be used as the dispersant, it is preferred to dry the dispersant at a high temperature of at least 120° C. by using an air dryer in order to completely remove the dispersant. On the other hand, in a case where a highly volatile dispersant is to be used, drying may be done at a low temperature of at most 100° C.

In the porous film layer 40, a plurality of base materials 10 with a coating film are bonded together via the coating film, and voids are formed between the plurality of base materials 10 with a coating film. Since the electrolyte can permeate into the voids, the porous film layer 40 does not interfere with the battery reaction.

The thickness of the porous film layer 40 is, for example, at least the average particle size of the base material 10 with a coating film and at most 10 μm.

The porous film layer 40 may be formed on one surface or on both surfaces of the separator 30.

[Method of Producing Base Material with Coating Film]

The method for producing a base material with a coating film according to one embodiment of the present invention (hereinafter referred to also as “the present production method”) is a method of heating a base material, a fluororesin with an MFR of from 0.01 to 100 g/10 min and a halogenated solvent to a temperature T₁ of at least (the melting point of said fluororesin −20° C.) and less than (the decomposition temperature of said fluororesin) in such a state as they are in contact with one another, and cooling them to a temperature T₂ of at most (the melting point of said fluororesin −50° C.).

After cooling to the temperature T₂, typically the halogenated solvent is removed.

After cooling to the temperature T₂, they may be further cooled to a temperature T₃ lower than the temperature T₂ before removing the halogenated solvent.

The base material and the fluororesin are, respectively, as described above. However, the shape of the base material is not limited to particles or a porous body, and may be another shape, such as a plate. From the viewpoint of usefulness of the present invention, particles or a porous body is preferred.

The halogenated solvent is a substance having halogen atoms and being liquid at 25° C.

As the halogen atoms, fluorine atoms, chlorine atoms, etc. may be mentioned. The halogen atoms which the halogenated solvent has, may be one type, or two or more types.

As the halogenated solvent, one which does not dissolve the fluororesin at the temperature T₂ and which dissolves the fluororesin at the temperature T₁, is used.

When the base material, the fluororesin and the halogenated solvent are heated to the temperature T₁ in such a state as they are in contact with one another, the fluororesin will dissolve in the halogenated solvent. Then, when they are cooled to the temperature T₂, the fluororesin will be deposited on the surface of the base material whereby a coating film will be formed.

The halogen content of the halogenated solvent is preferably from 60 to 96 mass %, more preferably from 70 to 90 mass %, further preferably from 75 to 80 mass %. When the halogen content is within the above range, the fluororesin solubility will be more excellent.

The halogen content is the mass ratio of halogen atoms to the total mass of the halogenated solvent.

The weight average molecular weight of the halogenated solvent is preferably from 130 to 1,500, more preferably from 300 to 1,200, further preferably from 500 to 1,000. When the above weight average molecular weight is at least the above lower limit value, the pressure increase in the system due to vaporization during the heating can be suppressed and operability will be more excellent, and when it is at most the upper limit value, the viscosity during the heating will be low, and the solubility will be better.

The weight average molecular weight of the halogenated solvent is the weight average molecular weight calculated as standard polystyrene, measured by gel permeation chromatography.

Specific examples of the halogenated solvent may be

PCTFE with an average molecular weight of from about 500 to 1,000 (e.g. DAIFLOIL #1, #3, #10, #20, etc., manufactured by Daikin Industries, Ltd.);

perfluoro cyclic ethers such as perfluoro(2-n-butyltetrahydrofuran) (e.g. FLUORINERT FC-75 manufactured by 3M);

perfluorocycloalkanes and their oligomers, such as perfluorodecalin, perfluoro(tetradecahydrophenanthrene), oligomers of perfluoro(tetradecahydrophenanthrene) (e.g. FLUTEC PP11 and PP11 oligomers, manufactured by F2 Chemicals Ltd.);

fluorinated aromatic compounds, such as fluorinated benzonitrile, fluorinated benzoic acid and its esters, fluorinated aromatic hydrocarbons, fluorinated nitrobenzene, fluorinated phenylalkyl alcohols, fluorinated phenol esters, fluorinated aromatic ketones, fluorinated aromatic ethers, fluorinated aromatic carbonates, polyfluoroalkyl esters of benzoic acid, polyfluoroalkyl esters of phthalic acid, etc.;

hydrofluoroethers (HFE) such as CF₃CH₂OCF₂CF₂H, CF₃(CF₃)₂CFCF₂OCH₃, CF₃(CF₂)₃OCH₃, CF₃(CF₂)₃OC₂H₅, etc.; and

hydrofluorocarbons (HFC), such as CF₃CFHCF₂CF₂CF₃, CF₃(CF₂)₄H, CF₃CF₂CFHCF₂CF₃, CF₃CFHCFHCF₂CF₃, CF₂HCFHCF₂CF₂CF₃, CF₃(CF₂)₅H, CF₃CH(CF₃)CF₂CF₂CF₃, CF₃CF(CF₃)CFHCF₂CF₃, CF₃CF(CF₃)CFHCFHCF₃, CF₃CH(CF₃)CFHCF₂CF₃, CF₃CF₂CH₂CH₃, CF₃(CF₂)₃CH₂CH₃ etc.

The average molecular weight of PCTFE is the weight average molecular weight as calculated as standard polystyrene, measured by gel permeation chromatography.

One type of these halogenated solvents may be used alone, or two or more types of them may be used in combination.

Among these, perhalogenated solvents such as PCTFE, perfluorocyclic ethers, perfluorocycloalkanes, and their oligomers are preferred because of their relatively high boiling points and their ability to suppress excessively high pressures in the system during the heating.

The ratio of the fluororesin to 100 parts by mass of the halogenated solvent is preferably more than 0 and at most 30 parts by mass, more preferably from 0.001 to 5 parts by mass, further preferably from 0.01 to 1 part by mass. When the ratio of the fluororesin is at least the above lower limit value, the fluororesin can be coated on the surface of the base material without defects, and when the ratio is at most the above upper limit value, the viscosity of the solution in which the fluororesin is dissolved in the halogenated solvent will be low, and the film will be easily formed evenly.

In a case where the base material is particles, the ratio of the base material to 100 parts by mass of the halogenated solvent is preferably from 0.1 to 30 parts by mass, more preferably from 0.5 to 10 parts by mass, further preferably from 1 to 5 parts by mass. When the ratio of the base material is at least the above lower limit value, the concentration of particles in the halogenated solvent becomes uniform and the precipitation of the fluororesin alone can be suppressed, and when the ratio is at most the above upper limit value, the increase in viscosity of the halogenated solvent due to particles can be suppressed, and the film can be formed uniformly.

The ratio of the fluororesin to 100 parts by mass in total of the base material and the fluororesin is suitably selected according to the average thickness of the coating film to be formed, taking into consideration the surface area of the base material. The preferred average thickness of the coating film is as described above.

In a case where the base material is particles, the ratio of the fluororesin to 100 parts by mass in total of the base material and the fluororesin is preferably from 0.01 to 50 parts by mass, more preferably from 0.1 to 20 parts by mass, further preferably from 0.5 to 10 parts by mass. When the ratio of the fluororesin is at most the above upper limit value, it will be easier to keep the average thickness of the coating film to be at most the above preferred upper limit value, and when the ratio is at least the above lower limit value, the uniformity of the thickness of the coating film to be formed will be more excellent.

As the method of heating the base material, the fluororesin and the halogenated solvent to a temperature T₁ in such a state that they are in contact with one another, and cooling them to a temperature T₂, for example, a method of using a pressure-resistant container equipped with a jacket and a thermometer, may be mentioned. After the base material, the fluororesin and the halogenated solvent are contained in the pressure-resistant container and the pressure-resistant container is sealed, the pressure-resistant container may be heated by the jacket until the liquid temperature in the pressure-resistant container reaches T₁, or cooled until the liquid temperature reaches T₂.

The temperature T₁ is at least (the melting point of said fluororesin −20° C.) and less than (the decomposition temperature of said fluororesin), and is preferably at least (the melting point of said fluororesin −10° C.) and at most (the decomposition temperature of said fluororesin −20° C.) and more preferably at least (the melting point of said fluororesin) and at most (the decomposition temperature of said fluororesin −30° C.). When the temperature T₁ is at least the above lower limit value, the fluororesin can be easily dissolved in the halogenated solvent, and when it is at most the above upper limit value, decomposition of the fluororesin can be suppressed.

The temperature T₂ is at most (the melting point of said fluororesin −50° C.), preferably at most (the melting point of said fluororesin −80° C.), further preferably at most (the melting point of said fluororesin −100° C.). When the temperature T₂ is at most the above upper limit value, it will be easy to precipitate the fluororesin.

The lower limit of the temperature T₂ is not particularly limited, but is, for example, room temperature.

The cooling rate during cooling from the temperature T₁ to the temperature T₂ is preferably at most 5° C./min, more preferably at most 2° C./min, further preferably at most 1° C./min. When the cooling rate is at most the above upper limit value, the fluororesin can be precipitated only on the surface of the base material, and precipitation of the fluororesin alone can be suppressed.

The lower limit of the cooling rate is not particularly limited and may be more than 0° C./min, but, in consideration of the productivity, at least 0.5° C./min is preferred.

After cooling to the temperature T₂, the cooling rate for further cooling to the temperature T₃ is not particularly limited. Further, the cooling at that time may be conducted under a liberated atmosphere.

The temperature T₃ is, for example, room temperature.

After the cooling, by removing the halogenated solvent, the base material with the coating film can be recovered.

As the method for removing the halogenated solvent, a known solid-liquid separation method such as filtration may be used.

After removing the halogenated solvent, as the case requires, treatment such as washing, drying or the like may be conducted.

### EXAMPLES

In the following, the present invention will be described in detail by using Examples, but the present invention is not limited to these Examples. The “parts” is “parts by mass”. The “room temperature” is 25° C.

Ex. 1 to 7 are Examples of the present invention, and Ex. 8 is a Comparative Example.

### (MFR)

Using a melt indexer manufactured by Techno Seven Co., Ltd., the mass (g) of the fluororesin flowing out for 10 minutes (unit time) from a nozzle of 2 mm in diameter and 8 mm in length at 372° C. under a load of 49N for PFA and PTFE and at 297° C. under a load of 49N for ETFE, was measured, and the measured value was adopted as MFR.

### (Melting Point)

Using a differential scanning calorimeter (DSC device) manufactured by Seiko Instruments Inc., the melting peak of the fluororesin was recorded when the temperature was raised at a rate of 10° C./min, and the temperature (° C.) corresponding to the maximum value was adopted as the melting point.

### (Decomposition Temperature)

Using a simultaneous differential thermogravimetric analyzer (TG-DTA device) manufactured by Seiko Instruments Inc., the temperature at which the mass decrease rate of the fluororesin was 0.1% when the temperature was raised at a rate of 5° C./min, was adopted as the decomposition start temperature.

### (Materials Used)

As the fluororesins, the following were used.

ETFE: a copolymer of TFE units/ethylene units/HFP units/CH₂═CH(CF₂)₄F units/IAH units=49.2/41.7/7.8/1.0/0.3 (mol %) (melting point: 190° C., MFR: 79 g/10 min, decomposition temperature: 310° C.

PTFE: Fluon PTFE Lub L173JE manufactured by AGC Inc. (melting point: 327° C., MFR: 0.01 to 1.0 g/10 min, decomposition temperature: 390° C., containing no functional group I).

PFA-1: Fluon PFA P63P manufactured by AGC Inc. (melting point: 308° C., MFR: 10 g/10 min, decomposition temperature: 380° C., containing no functional group I)

PFA-2: a copolymer of NAH units/TFE units/PAVE units=0.1/97.9/2.0 (mol %) (melting point: 300° C., MFR: 16 g/10 min, decomposition temperature: 380° C.).

As the alumina particles, α-alumina (average particle size: 0.5 μm, manufactured by FUJIFILM Wako Pure Chemical Corporation) was used.

### (Ex. 1)

Into a pressure-resistant portable reactor (manufactured by TAIATSU TECHNO CORPORATION, TVS-N2 type, inner capacity: 50 mL), 50 g of a fluorinated solvent (manufactured by Daikin Industries, Ltd., DAIFLOIL #10, low polymerization of chlorotrifluoroethylene with an average molecular weight of about 900, colorless transparent heavy oil state at 25° C.), 2.5 g of alumina particles (5 parts to 100 parts of the fluorinated solvent), and 125 mg of ETFE (0.25 part to 100 parts of the fluorinated solvent) were put. The reactor was sealed and heated to a liquid temperature of 180° C. by a mantle heater. After maintaining the temperature at 180° C. for 1 hour, the temperature was lowered to 120° C. at a rate of 1° C./min. The solution was then cooled to room temperature, and the obtained reaction solution was filtered to obtain alumina particles with a coating film.

### (Ex. 2)

The respective materials were put into the reactor in the same ratio as in Ex. 1, except that ETFE was changed to PTFE. The reactor was sealed and heated to a liquid temperature of 310° C. by a mantle heater, held for 1 hour, and then lowered to 260° C. at 1° C./min. The solution was then cooled to room temperature, and the obtained reaction solution was filtered to obtain alumina particles with a coating film.

### (Ex. 3)

The respective materials were put into the reactor in the same ratio as in Ex. 1, except that ETFE was changed to PFA-1. The reactor was sealed and heated to a liquid temperature of 300° C. by a mantle heater, held for 1 hour, and then lowered to 250° C. at 1° C./min. The solution was then cooled to room temperature, and the obtained reaction solution was filtered to obtain alumina particles with a coating film.

### (Ex. 4)

Alumina particles with a coating film were obtained in the same manner as in Ex. 3, except that PFA-1 was changed to PFA-2.

### (Ex. 5)

Alumina particles with a coating film were obtained in the same manner as in Ex. 1, except that the amount of ETFE was changed from 125 mg to 75 mg (0.15 part to 100 parts of the fluorinated solvent).

### (Ex. 6)

Alumina particles with a coating film were obtained in the same manner as in Ex. 1, except that the amount of ETFE was changed from 125 mg to 25 mg (0.05 part to 100 parts of the fluorinated solvent).

### (Analysis 1 of Particles: FT-IR)

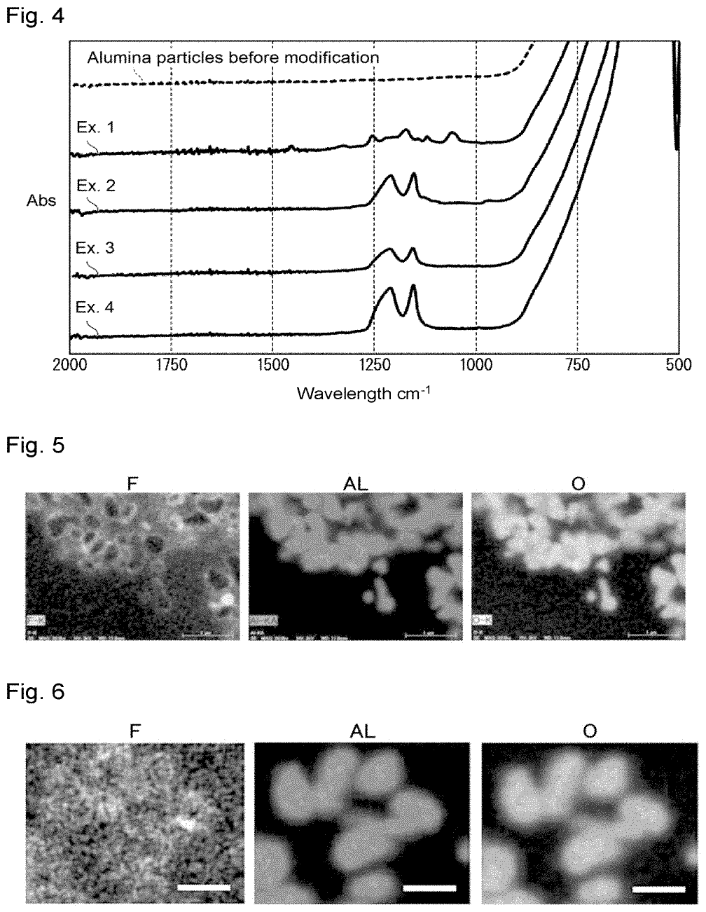

The alumina particles with a coating film in Ex. 1 to 4 and alumina particles before forming the coating film (hereinafter referred to also as “alumina particles before modification”) were, respectively, analyzed by ATR (Attenuated Total Reflection) type FT-IR (Fourier Transform Infrared Spectrometer) (manufactured by Thermo Fisher Scientific K.K., NICOLET iS5 and ATR unit iD7). The evaluation results are shown in FIG. 4.

With respect to the alumina particles with a coating film in Ex. 1 to 4, a peak derived from the fluororesin was observed at from 1,000 to 1,500 cm⁻¹, and thus the presence of the fluororesin was confirmed.

### (Analysis 2 of Particles: SEM/EDS)

The alumina particles with a coating film in Ex. 1 to 4 were, respectively, embedded in an epoxy resin, and the epoxy resin was cured. After the curing, the cross section and surface of the sample were polished and coated with Pt (film thickness: approx. 5 nm), and then the cross section was processed by using an ion-milling device (manufactured by Hitachi High-Technologies Corporation: E-3500). After the processing, a carbon coating (film thickness: approx. 15 nm) was applied to the cross section, and SEM (Scanning Electron Microscope)/EDS (Energy Dispersive X-ray Spectrometer) analysis was conducted (equipment: SU-8230 manufactured by Hitachi High-Technologies Corporation, and Quantax XFlashFQ manufactured by Bruker, Accelerating voltage: 3 kV, Emission: 30 μA, Probe current: High, Detector: SE(U)).

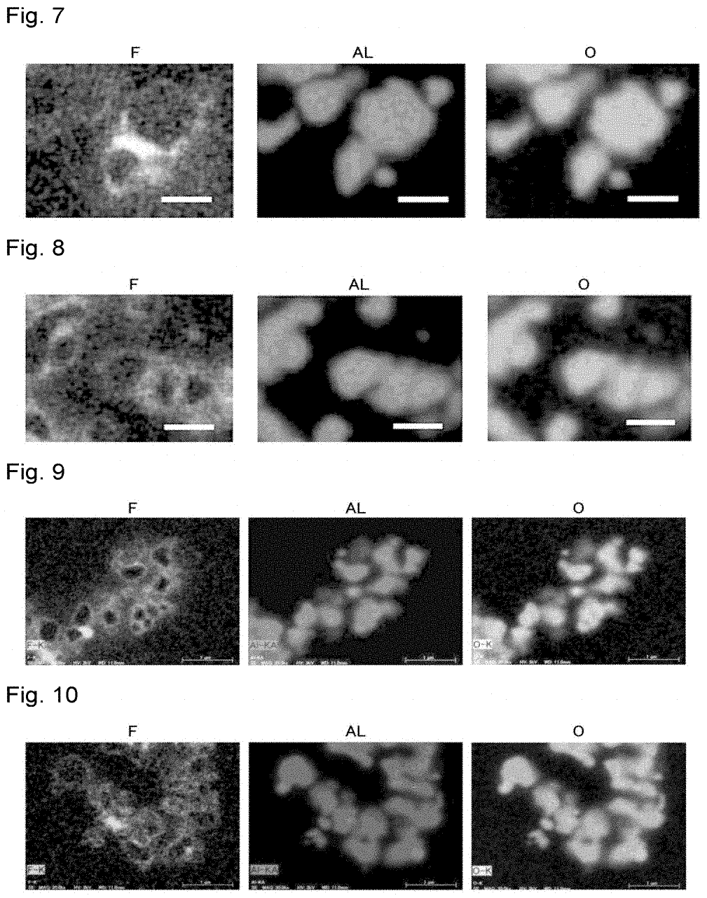

The results of the observations are shown in FIGS. 5 to 8. The scale bar in FIG. 5 is 1 μm, and the scale bar in FIGS. 6 to 8 is 500 nm.

From the results of EDS observation, F atoms were observed on the surface of the alumina particles with a coating film in Ex. 1 to 4, and thus, it was confirmed that the surface of the alumina particles was coated with the fluororesin.

### (Analysis 3 of Particles)

The alumina particles with a coating film in Ex. 5 and 6 were analyzed in the same manner as in the above described “Analysis 2 of particles”. The results are shown in FIGS. 9 to 10. The scale bar in FIGS. 9 to 10 is 1 μm.

From the results of EDS observation, F atoms were observed on the surface of the alumina particles with a coating film in Ex. 5 and 6, and thus it was confirmed that the surface of the alumina particles was coated with the fluororesin.

### (Analysis 4 of Particles)

With respect to the alumina particles with a coating film in Ex. 1, 5 and 6, by using a TG-DTA device (manufactured by Seiko Instruments Inc., TA7200), the mass decrease when heated at 450° C. for 1 hour in the atmosphere (the mass decrease due to thermal decomposition of the fluororesin) was measured. By the mass decrease (g)/the total mass of the alumina particles with a coating film (g)×100, the mass ratio (mass %) of the fluororesin to the total mass of the alumina particles with a coating film, was calculated. Further, by 100—the mass ratio of the fluororesin (mass %), the mass ratio (mass %) of the alumina particles to the total mass of the alumina particles with a coating film, was calculated. The results are shown in Table 1.

Further, with respect to the alumina particles with a coating film in Ex. 1, 5 and 6, the coating film mass (the fluororesin mass) was obtained from the mass decrease at the time of heating to 600° C. by a TG-DTA apparatus in the atmosphere. The resin density of ETFE was 1.73 g/cm³. The average thickness of the coating film was obtained by dividing the resin volume obtainable from the above coating film mass and resin density by the particle surface area. The results are shown in Table 1.

From the results in Table 1, it was found that the mass of fluororesin coating the base material, and thus the average thickness of the coating film, can be adjusted in proportion to the amount of the fluororesin to be charged at the time of producing the base material with a coating film.

TABLE 1

| | Ex. 1 | Ex. 5 | Ex. 6 |
|---|---|---|---|
| Fluororesin (mass %) | 5.1 | 2.8 | 1.2 |
| Alumina particles (mass %) | 94.9 | 97.2 | 98.8 |
| Average thickness (nm) | 10.2 | 5.48 | 2.31 |

### (Ex. 7)

In order to use alumina particles coated with a fluororesin, as a surface coating material for a separator of a lithium-ion secondary battery, lamination to the separator was conducted.

The alumina particles with a coating film in Ex. 1 were dispersed in N-methylpyrrolidone so that the solid content became 20 wt %. The obtained dispersion was applied to the surface of a separator (manufactured by Asahi Kasei Corporation, Celgard 2400), and the surface after the application was washed twice with N-methylpyrrolidone and dried at 80° C. for 2 hours. Thus, a laminated separator having the particles fixed to the separator surface was obtained.

### (Ex. 8)

To an ETFE composition obtained in the same manner as in Example 1-1 of WO2019/031521 (solvent: diisopropyl ketone, fluororesin concentration: 2 mass %), alumina particles were added and dispersed to obtain a dispersion. The alumina particles were added so that the mass ratio of the alumina particles to the total mass of the dispersion became 20 mass %. The obtained dispersion was applied to the surface of a separator in the same manner as in above described Ex. 7, washed and dried. However, the alumina particles were peeled off from the separator during the washing process, and the separator could not be coated.

### REFERENCE SYMBOLS

1: Base material (particle)

3: Base material (porous body)

5: Coating film of a fluororesin

10: Base material with a coating film

20: Base material with a coating film

30: Separator

40: Porous film layer

This application is a continuation of PCT Application No. PCT/JP2021/006397, filed on Feb. 19, 2021, which is based upon and claims the benefit of priority from Japanese Patent Application No. 2020-033334 filed on Feb. 28, 2020. The contents of those applications are incorporated herein by reference in their entireties.

What is claimed is:

1. A base material with a coating film, comprising a base material being particles or a porous body, and a coating film of a fluororesin covering the surface of the base material, wherein the melt flow rate of the fluororesin is from 0.01 to 100 g/10 min.

2. The base material with a coating film according to claim 1, wherein the average thickness of the coating film is at most 1 μm.

3. The base material with a coating film according to claim 1, wherein the fluororesin is at least one member selected from the group consisting of a polymer having units based on tetrafluoroethylene, a copolymer having units based on ethylene and units based on tetrafluoroethylene, a copolymer having units based on a perfluoro(alkyl vinyl ether) and units based on tetrafluoroethylene, a copolymer having units based on hexafluoropropylene and units based on tetrafluoroethylene, and a polymer having units based on chlorotrifluoroethylene.

4. The base material with a coating film according to claim 1, wherein the base material is an inorganic base material.

5. A method for producing a base material with a coating film, which comprises heating a base material, a fluororesin having a melt flow rate of from 0.01 to 100 g/10 min. and a halogenated solvent in such a state as they are brought into contact with one another, to a temperature T₁ of at least (the melting point of the fluororesin −20° C.) and less than (the decomposition temperature of the fluororesin), and cooling them to a temperature T₂ of at most (the melting point of the fluororesin −50° C.).

6. The production method according to claim 5, wherein the base material is particles or a porous body.

7. The production method according to claim 5, wherein the halogen content of the halogenated solvent is from 60 to 96 mass %.

8. The production method according to claim 5, wherein the weight average molecular weight of the halogenated solvent is from 130 to 1,500.

9. The production method according to claim 5, wherein the fluororesin is at least one member selected from the group consisting of a polymer having units based on tetrafluoroethylene, a copolymer having units based on ethylene and units based on tetrafluoroethylene, a copolymer having units based on a perfluoro(alkyl vinyl ether) and units based on tetrafluoroethylene, a copolymer having units based on hexafluoropropylene and units based on tetrafluoroethylene, and a polymer having units based on chlorotrifluoroethylene.

10. The production method according to claim 5, wherein the base material is an inorganic base material.

11. The production method according to claim 5, wherein the cooling rate at the time of cooling to the temperature T₂ is at most 5° C./min.

12. The production method according to claim 5, wherein the proportion of the fluororesin to 100 parts by mass of the halogenated solvent is more than 0 part by mass and at most 30 parts by mass.

13. The production method according to claim 5, wherein the base material is particles, and the proportion of the base material to 100 parts by mass of the halogenated solvent is from 0.1 to 30 parts by mass.
